(19) United States
(12) Patent Application Publication
(10) Pub. No.: US 2008/0168710 A1
(43) Pub. Date: Jul. 17, 2008

(54) Modular Planting System For Roof Applications

(76) Inventor: David S. MacKenzie, Nunica, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/623,168

(22) Filed: Jan. 15, 2007

(51) Int. Cl. A01G 9/02

(52) U.S. Cl. 47/65.9

(57) ABSTRACT

A modular planting system for roof applications includes a plurality of green roof planter modules each including a bottom wall, a plurality of sidewalls that cooperate with the bottom wall to form an interior space, and a plurality of support tabs extending inwardly towards the interior space. Each module further includes a removable collar member extending upwardly from the plurality of sidewalls, wherein the collar member is supported within the interior space by the support tabs, and wherein the collar member is adapted to retain a plant matter that extends above the sidewalls.

### BACKGROUND OF THE INVENTION

The present invention relates to a modular planting system for roof applications, and in particular to a modular planting system that includes a plurality of planter modules each including a planter and a removable collar member extending upwardly from an uppermost portion of the planter, thereby allowing plant matter to extend above the upper edge of the associated planter and the removable collar to be removed once the planter module is placed adjacent to a plurality of other planter modules, thereby creating a green-roof system.

Green-roof systems are used in a wide variety of applications, including commercial and residential buildings. The positive thermal properties of the systems result in significant cost savings with respect to cooling of the associated buildings and structures. Further, the systems dramatically reduce the amount of water runoff caused by rainfall, which is particularly critical in urban areas. The systems typically include a soil or aggregate matter supporting plants therein, and barrier layers for protecting the underlying roof and for providing the necessary water barriers and drainage for the associated plants. These methods may include the application of seed-including soils to the selected roof area. However, this method typically requires a significant amount of time until the plants provide adequate coverage. Other methods that have been employed include the use of modular systems, thereby reducing the grow-time required in order to provide adequate coverage by allowing plants to at least partially mature prior to being utilized within a green roof system. However, these systems employ normal planter boxes wherein the plant matter rests below an uppermost edge of the associated planter or container. Such methods, while a vast improvement over previous methods, typically result in several months to years of grow time while the individual sections grow and subsequently fuse together to provide adequate roof coverage. Another problem typically associated with past methods is the inadequacy of water supply, drainage and transport between the associated sections.

A planted roof system is desired that provides adequate roof coverage quickly and economically, while simultaneously being easy to install at a relative low cost. Further, the system should provide improved water communication between the modules that comprise the overall system, and allow easy maintenance thereof.

### SUMMARY OF THE INVENTION

One aspect of the present invention is to provide a green roof planter module that comprises a planter, including a bottom wall, a plurality of sidewalls that cooperate with the bottom wall to form an interior space, and at least one support tab that extends inward towards the interior space from at least a select one of the bottom wall and the plurality of sidewalls. The planter module further comprises a removable collar member extending upwardly from at least a select one of the plurality of sidewalls, wherein the collar member is supported within the interior space by the at least one support tab, and wherein the collar member is adapted to retain a plant matter that extends above the plurality of sidewalls.

Another aspect of the present invention is to provide a green roof planter module that comprises a planter including a bottom wall, a plurality of sidewalls, including an upper edge and that cooperate with the bottom wall to form an interior space, wherein the upper edge of each of the sidewalls includes an upwardly-opening channel. The planter module further comprises a removable collar member extending upwardly from at least a select one of the plurality of sidewalls, wherein the collar member is supported within the channels of the sidewalls and extends inwardly from the top edges of the sidewalls, and wherein the collar member is adapted to retain a plant matter that extends above the plurality of sidewalls.

Yet another aspect of the present invention is to provide a method for installing a modular green roof system that comprises providing a planter that includes a bottom wall and a plurality of sidewalls, each having an upper edge and that cooperate with the bottom wall to inform an interior space, and providing a removable collar member having a bottom edge and a top edge. The method further includes inserting the removable collar into the interior space of the planar such that the removable collar extends upwardly from at least a select one of the plurality of sidewalls, and placing and growing a plant matter within the interior space of the planter such that at least a portion of the plant matter extends upwardly from the upper edge of the plurality of sidewalls. The method still further includes positioning the planter proximate to at least one other planter, and removing the collar member from within the interior space of the planter such that a portion of the plant matter extending upwardly from the upper edge of the planter abuts a portion of plant matter extending upwardly from an upper edge of the at least one other planter.

Yet another aspect of the present invention is to provide a green roof planter module that comprises a planter including a bottom wall, a plurality of sidewalls that cooperate with the bottom wall to form an interior space, and at least one aperture extending through at least one of the sidewalls of the plurality of sidewalls The planter module further comprises a removable collar member extending upwardly from at least a select one of the plurality of sidewalls, wherein the collar includes at least one relief therein, and wherein the collar member is adapted to retain a plant matter that extends above the plurality of sidewalls, and a retainer member that extends into the at least one aperture of the at least one sidewall of the planter and the at least one relief of the collar, thereby removably retaining at least a portion of the collar within the interior space of the planter.

Still yet another aspect of the present invention is to provide a green roof planter module that comprises a bottom wall adapted to support a planter module from a supporting surface, a pair of sidewalls extending upwardly from the bottom wall, and a pair of end walls extending upwardly from the bottom wall, wherein the bottom wall, the sidewalls and the end wall cooperate to form an interior space. The planter module further comprises a pair of release extending into a portion of the bottom wall and the end walls, wherein the release are adapted to provide clearance between the planter module and a supporting surface to allow a user to grip the planter module.

Another aspect of the present invention is to provide a green roof planter module that comprises a planter including a bottom walt, and a plurality of sidewalls that cooperate with the bottom wall to form an interior space, wherein each of the sidewalls includes a top edge and a bottom edge, at Least one of the sidewalls of the plurality of sidewalls includes a relief extending through the at least one sidewall and extending greater than half of a distance between the top edge to the bottom edge of the at least one sidewall, wherein the relief is adapted to provide fluid communication between the planter module and a proximate second planter module.

Still yet another aspect of the present invention is to provide a green roof planter module that comprises a drainage member including a bottom surface, a top surface having at least one downwardly-extending recess, and a plurality of side surfaces, and a planter separate from the drainage member and including a bottom wall abutting the top surface of the drainage member and having at least one drainage aperture in fluid communication with the at least one recess of the drainage member, thereby allowing fluid communication between the at least one aperture and the at least one recess. The at least one recess extends through at least one of the plurality of side surfaces, thereby providing fluid communication between the planter module and an adjacent planter module.

The present inventive green roof system provides coverage of an entire roof area quickly and economically by allowing the associated modules to be grown off-sight in a manner that allows the plant matter to extend upwardly from an associated planter and plant matter within adjacent modules to abut immediately upon installation. Further, the roof system is easy to install at a relatively Low cost. Moreover, the system provides improved water communication and drainage between adjacent modules, allows easy maintenance of the overall system, can be installed easily and quickly by even unskilled personnel, is capable of a Long-operating life, and is particularly well adapted for the proposed use.

These and other advantages of the invention will be further understood and appreciated by those skilled in the art by reference to the following written specification, claims and appended drawings.

### BRIEF DESCRIPTION OF THE DRAWINGS

FIG. 1 is a perspective view of a building employing a green roof system embodying the present invention;

FIG. 2 is a perspective view of a green roof planter module that includes a collar member removably inserted into an associated planter;

FIG. 3 is an exploded perspective view of the planter module;

FIG. 4 is an enlarged perspective view of the planter module including a cut-away portion of the collar member inserted into the planter;

FIG. 5A is a partial cross-sectional end view of the planter module;

FIG. 5B is a partial cross-sectional end view of an alternative embodiment of the planter module;

FIG. 6 is an end view of the planter;

FIG. 7 is a partial cross-sectional view of another alternative embodiment of the planer module;

FIG. 8 is a top perspective view of another alternative embodiment of the planter module including a planter and a supporting drainage member; and

FIG. 9 is a top plan view of the drainage member.

### DETAILED DESCRIPTION OF THE PREFERRED EMBODIMENTS

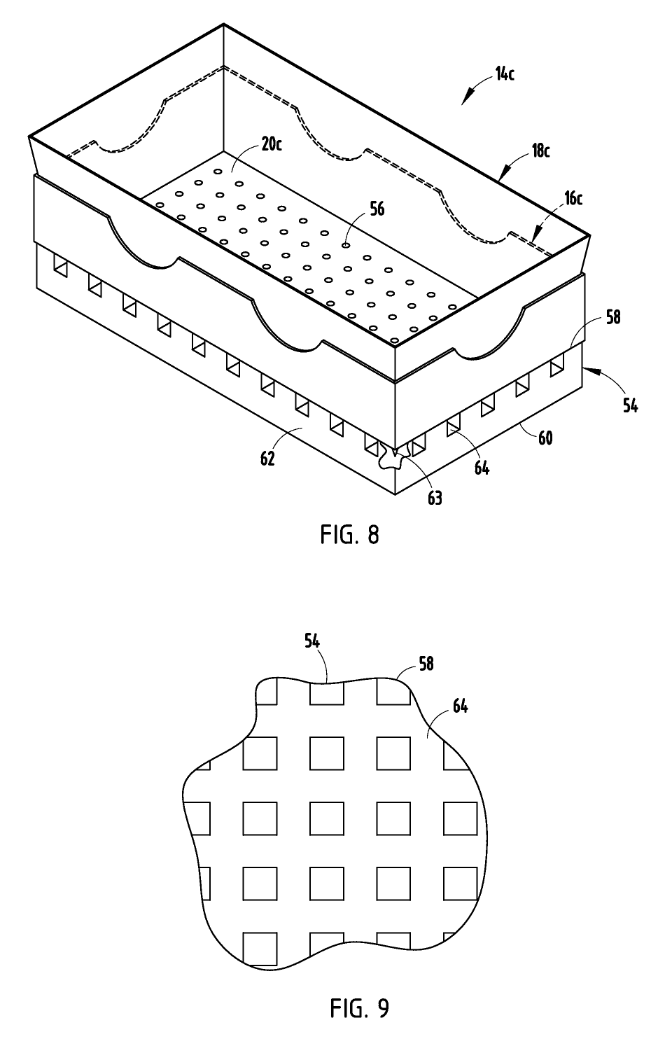

For purposes of description herein, the terms “upper”, “lower,” “right,” “left,” “rear,” “front,” “vertical,” “horizontal,” and derivatives thereof shall relate to the invention as oriented in FIGS. 2 and 8. However, it is to be understood that the invention may assume various alternative orientations and step sequences, except where expressly specified to the contrary. It is also to be understood that the specific devices and processes illustrated in the attached drawings, and described in the following specification are exemplary embodiments of the inventive concepts defined in the appended claims. Hence, specific dimensions and other physical characteristics relating to the embodiments disclosed herein are not to be considered as limiting, unless the claims expressly state otherwise.

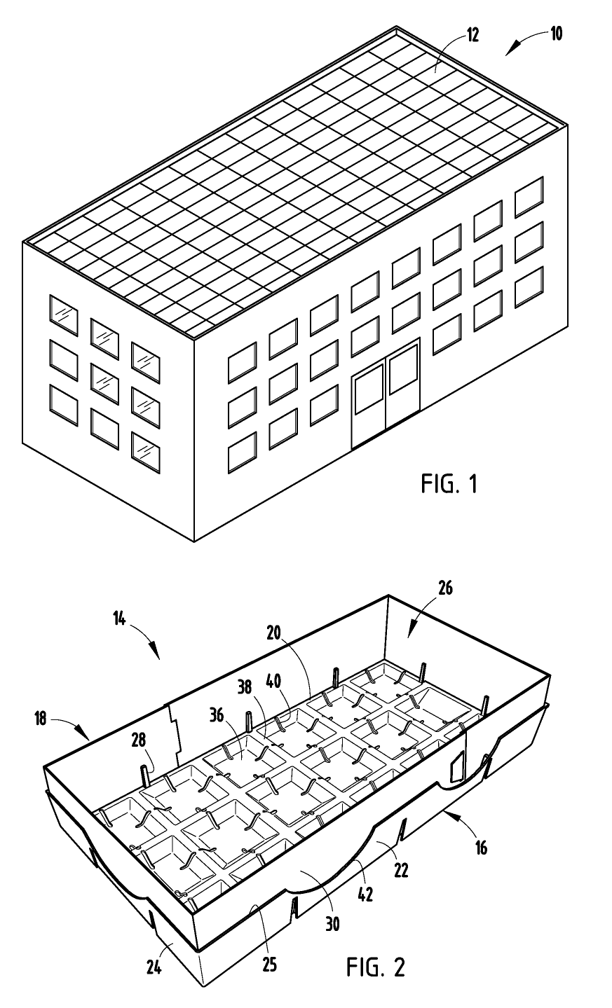

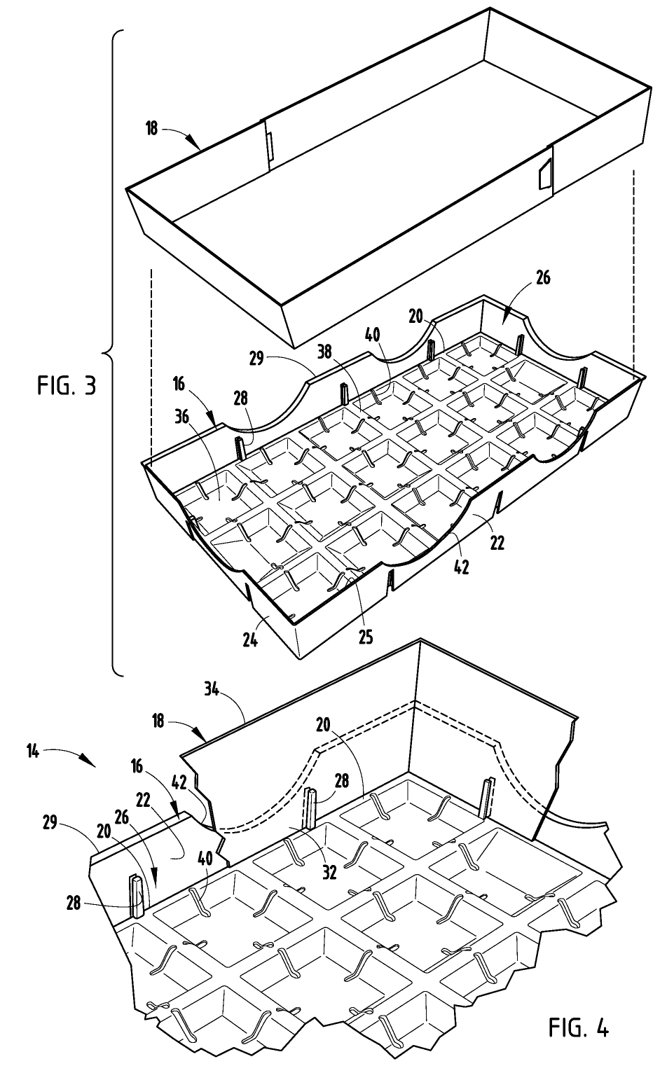

The reference numeral 10 (FIG. 1) generally designates a green roof system embodying the present invention and employed on a building roof 12 and comprising a plurality of individual green roof planter modules 14. In the illustrated example, each of the planter modules 14 (FIGS. 2 and 3) comprises a planter 16 and a removable collar 18 inserted into the planter 16 such that the collar 18 extends upwardly from an uppermost edge of the planter 16, thereby allowing the retention of plant matter that extends above an upper edge of the planter 16.

Each planter 16 includes a bottom wall 20, a plurality of walls that include sidewalls 22 and end walls 24 that cooperate with the bottom wall 20 to form an interior space 26, and a plurality of support tabs 28 (FIGS. 4 and 5) spaced about the interior space 26 and that extend inwardly toward the interior space 26. Each of the sidewalls and end walls include a top edge 25. As best illustrated in FIG. 4, each of the support tabs 28 extends upwardly from the bottom wall 20 and is spaced from an associated sidewall 22 or end wall 24. The planter 16 is preferably integrally molded by press forming, and the like, and is constructed of a material such as plastic. In the illustrated example, the planter 16 is providing a rectangularly-shaped overall plan form, however, other configurations may also be utilized. Further, it is noted that the tabs 28 are configured to abut the bottom surface of the bottom wall 20 of another planter 16 when multiple planters are placed in a stacked relationship. As illustrated, one of the sidewalls 22 and one of the end walls 24 each include an outwardly-extending overlap tab 29 that overlaps a respective sidewall or end wall of an adjacent planter 16.

The collar member 18 includes a plurality of walls 30 each having a bottom edge 32 and a top edge 34. In the illustrated example, the collar member 18 comprises two pieces that extend in a rectangular manner about the planter 16. Specifically, the collar member 18 extends about the interior space 26 of the associated planter 16 such that the bottom edge 32 of each of the walls 30 is inserted between the sidewalls and end walls 22, 24 of the planter 16 and the associated support tabs 28, thereby retaining the collar member 18 within the interior space 26 of the planter 16, and such that the walls 30 of the collar member 18 extend upwardly from the top edge 25 of the sidewalls and end walls 22, 24 of the planter 16. Although locking tabs are illustrated between each of the pieces of the collar, overlapping, non-tabbed ends may also be utilized.

In operation, the collar member 18 is inserted into the interior space 26 of planter 16, in a manner described above, and a plant matter that comprises grown plants, plant seedlings, plant seeds and the like, and soil and/or aggregate is also inserted into the interior space 26 of the planter 16. Subsequently, plants are grown within the interior space 26 until such plant matter extends upwardly above the top edge 25 of the sidewalls and end walls 22, 24 of the planter 16. The planter module 14 is then placed in rows or a grid work-like pattern upon a roof 12 (FIG. 1) and the collar member 18 removed such that the plant matter within the interior space 26 of the planter 16 abuts similar plant matter in adjacent planter modules 14, thereby providing a connected roof system that will quickly provide an interconnected and aesthetically-pleasing planted surface. Alternatively, the collar member 18 comprises a biodegradable material that may be left within the planter 16 placed within the overall grid work of the green roof system 10. It is also noted that the walls 30 of the collar member 18 angles outwardly from the sidewalls and end walls 22, 24 of the planter 16, thereby promoting a tight abutment of the plant matter extending above the top edge 25 of the sidewalls and end walls 22, 24 between adjacent planter modules 14.

The proper communication of water between adjacent planters 16 is provided by various elements within the planter 16. As best illustrated in FIG. 2, the bottom wall 20 of the planter 16 comprises a grid work-like pattern of recesses 36 segmented by raised portions 38. A plurality of drainage apertures 40 extend through the recesses 36 and the raised portions 38. It is noted that at least a portion of each of the drainage apertures 40 extend through a lowermost portion of the bottom wall 20, thereby eliminating standing water within the planter 16. Each of the sidewalls and end walls 22, 24 of the planter 16 also include arcuately-shaped recesses or apertures 42 extending therethrough that align with similar apertures of adjacent planters when positioned within the overall gridwork. As illustrated, each of the apertures extends downwardly from the top edge 25 of the sidewalls and end walls 22, 24, a distance that is greater than half of the distance between the top edge 25 and a point at which the bottom wall 20 intersects the sidewalls and/or end wall 22, 24, thereby providing adequate water communication between adjacent planters 16 and further allowing for the migration of plant matter therebetween.

The reference numeral 14a (FIG. 5B) generally designates another embodiment of the present inventive planter module. Since the planter module 14a is similar to the previously-described planter module 14, similar parts appearing in FIGS. 2-4 and FIG. 5, respectively are represented by the same, corresponding reference numeral, except for the suffix “a” in the numerals of the latter. In the planter module 14a, the top edge 25a of each of the sidewalls 22a and end walls 24a include an upwardly-opening channel 33 defining a pocket 35 within which the bottom edge 32a of the collar member 18a is inserted.

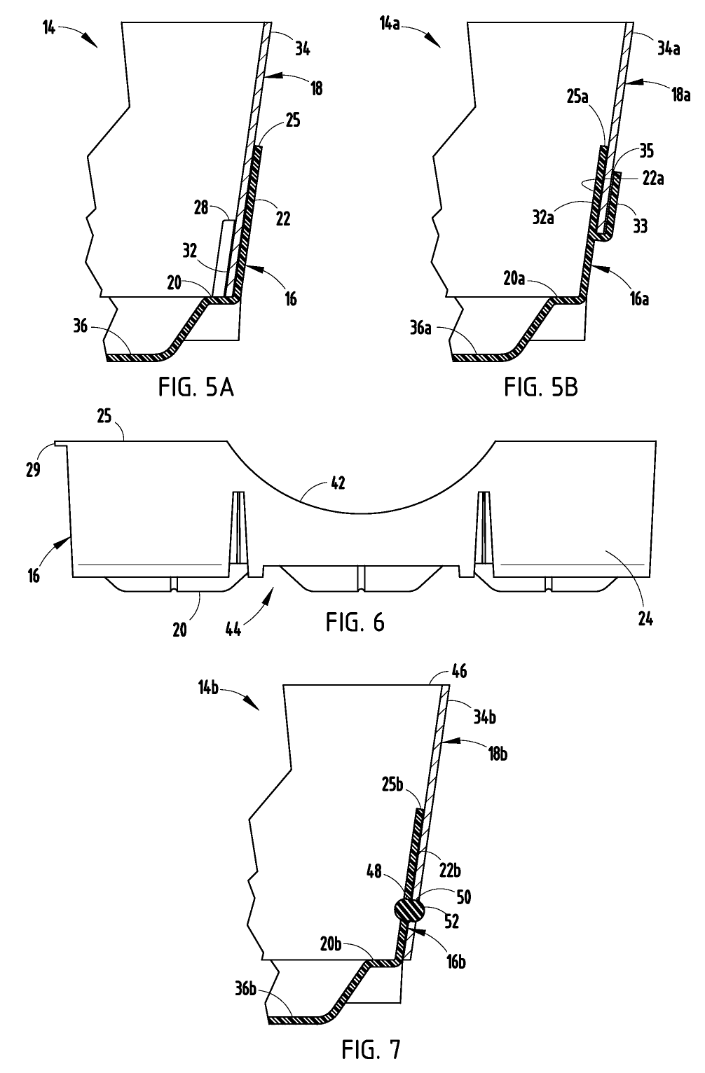

The planter 16 (FIG. 6) further includes a pair of gripping reliefs 44 located at each end thereof. Specifically, each relief 44 is provided within the intersection of an associated end wall 24 and the bottom wall 20 such that a user is able to insert their fingers into the reliefs 44, thereby allowing easy gripping and support of the planter module 14.

The reference numeral 14b (FIG. 7) generally designates another embodiment of the present inventive planter module 14. Since the planter module 14b is similar to the previously-described planter module 14, similar parts appearing in FIGS. 2-4 and FIG. 7, respectively are represented by the same, corresponding reference numeral, except for the suffix “b” in the numerals of the latter. In the planter module 14b, the intersecting corner 46 between the sidewalls 22b and the end walls (not shown) are provided with an aperture 48 extending therethrough, while corresponding corners of the collar member 18b are provided with an aperture or recess 50. The alternative embodiment planter module 14b further includes a retainer member that extends about the exterior of the sidewalls and end wall 22b, 24b of the planter 16b and extends into the aperture 48 of the planter 16b and the apertures 50 of the collar member 18b, thereby retaining the collar member 18b to the outside of the planter 16b. It is preferred that the retainer member 52 comprises an elastically-deformable material, such as an elastic cord or rubber band. The retainer member 52 assists in retaining the collar member 18b about the planter 16b, but allows easy removal of the retaining member 52 and the collar member 18b from about the planter 16b.

The reference numeral 14c (FIG. 8) generally designates another embodiment of the present inventive planter module. Since the planter module 14c is similar to the previously-described planter module 14, similar parts appearing in FIGS. 2-4 and FIGS. 8 and 9, respectively are represented by the same, corresponding reference numeral, except for the suffix “c” in the numerals of the latter. The planter module 14c includes a planter 16c, a collar member 18c, and a drainage member 54 supporting the planter 16c. The planter 16c and collar member 18c are similar to the previously-described planter 16 and collar member 18, the most notable exception being that the bottom wall 20c of the planter 16c is substantially flat with a plurality of drainage holes or apertures 56 extending therethrough. The drainage member 54 is provided substantially the same plan form shape as the planter 16c and includes a top wall 58, a bottom wall 60, and a plurality of sidewalls 62. As illustrated, the planter 16c includes a plurality of downwardly-extending pegs 63 that are embedded into the drainage member 54. As best illustrated in FIG. 9, the top wall 58 includes an inwardly-extending grid work of passages or recesses 64. These passages extend between and through the sidewalls 62 of the drainage member 54. In assembly, the bottom wall 20c of the planter 16c is supported on the top wall 58 of the drainage member 54 such that the drainage apertures 56 of the planter 16c aligns with the recesses 64 of the drainage member 64, thereby allowing water communication therebetween. Further, the recesses 64 of the drainage member 54 are arranged so as to align the recesses 64 of adjacent drainage members 54 within the overall grid work of planter modules 14c when placed upon the roof 12 of the associated building, thereby allowing proper fluid communication between all adjacent planter modules 14c. Preferably, the drainage member 54 is comprised of a deformable foam material that allows the bottom wall 60 to be easily deformed when placed upon an uneven roof surface thereby eliminating the need for blocking or altering any of the planters 16c. The foam material also provides insulative properties between the planters 16c and associated roof 12.

The present inventive green roof system provides coverage of an entire roof area quickly and economically by allowing the associated modules to be grown off-sight in a manner that allows the plant matter to extend upwardly from an associated planter and plant matter within adjacent modules to abut immediately upon installation. Further, the roof system is easy to install at a relatively Low cost. Moreover, the system provides improved water communication and drainage between adjacent modules, allows easy maintenance of the overall system, can be installed easily and quickly by even unskilled personnel, is capable of a long-operating life, and is particularly well adapted for the proposed use.

In the foregoing description, it will be readily appreciated by those skilled in the art, that modifications may be made to the invention without departing from the concepts as disclosed herein, such modifications are to be considered as included in the following claims, unless these claims by their language expressly state otherwise.

The invention claimed is:

1. A green roof planter module, comprising:
a planter including a bottom wall, a plurality of side walls that cooperate with the bottom wall to form an interior space, and at least one support tab that extends inward towards the interior space from at least a select one of the bottom wall and the plurality of side walls; and
a removable collar member extending upwardly from at least a select one of the plurality of sidewalls, wherein the collar member is supported within the interior space by the at least one support tab, and wherein the collar member is adapted to retain a plant matter that extends above the plurality of sidewalls.

2. The green roof planter module of claim 1, wherein the collar member completely surrounds the interior space.

3. The green roof planter module of claim 1, wherein the collar angles outwardly from the plurality of sidewalls.

4. The green roof planter module of claim 1 wherein the collar comprises a biodegradable material.

5. The green roof planter module of claim 1, wherein the at least one support tab includes a plurality of tabs spaced about the interior space.

6. The green roof planter module of claim 1, wherein the at least one support tab extends upwardly from the bottom wall.

7. The green roof planter module of claim 1, wherein the at least one support tab is spaced from at least one side wall of the plurality of side walls, and wherein collar is positioned between the at least one support tab and the at least one side wall.

8. The green roof planter module of claim 1, wherein the planter comprises a molded plastic.

9. The green roof planter module of claim 1, wherein the at least one tab of the planter module is adapted to space the bottom wall of the green roof planter from the bottom wall of a second planter module when in a stacked position with the planter module.

10. The green roof planter module of claim 1, wherein the bottom wall of the planter includes at least one drainage aperture located therein, and wherein at least a portion of the at least one drainage aperture is located with a lower most portion of the bottom wall.

11. The green roof planter module of claim 1, wherein the plurality of sides comprise a mesh.

12. The green roof planter module of claim 1, wherein at least one of the sidewalls of the planter includes an outwardly-extending tab that is adapted to overlap with a sidewall of an adjacent planter.

13. A green roof planter module, comprising:
a planter including a bottom wall, a plurality of side walls including an upper edge and that cooperate with the bottom wall to form an interior space, wherein the upper edge of each of side walls includes an upwardly opening channel; and
a removable collar member extending upwardly from at least a select one of the plurality of sidewalls, wherein the collar member is supported within the channels of the side walls and extends upwardly from the top edges of the side walls, and wherein the collar member is adapted to retain a plant matter that extends above the plurality of sidewalls.

14. The green roof planter module of claim 13, wherein the collar angles outwardly from the plurality of sidewalls.

15. The green roof planter module of claim 13, wherein the collar comprises a biodegradable material.

16. A method for installing a modular green roof system, comprising;
providing a planter that includes a bottom wall and a plurality of side walls each having an upper edge and that cooperate with the bottom wall to form an interior space;
providing a removable collar member having a bottom edge and a top edge;
inserting the removable collar into the interior space of the planter such that the removable collar extends upwardly from at least a select one of the plurality of sidewalls;
placing and growing a plant matter within the interior space of the planter such that at least a portion of the plant matter extends upwardly from the upper edge of the plurality of side walls;
positioning the planter proximate to at least one other planter; and
removing the collar member from within the interior space of the planter such that the portion of the plant matter extending upwardly from the upper edge of the planter abut a portion of plant matter extending upwardly from an upper edge of the at least one other planter.

17. The method of claim 16, wherein the step of providing the planter includes providing the planter with at least one support tab that extends inward towards the interior space from at least a select one of the bottom wall and the plurality of side walls, and wherein the step of inserting the removable collar into the interior space of the planter includes supporting the collar within the interior space by the at least one support tab.

18. The method of claim 16, wherein the step of providing the planter includes providing the planter such that the at least one support tab is spaced from at least one side wall of the plurality of side walls, and wherein the step of inserting the collar member includes positioning the collar member between the at least one support tab and the at least one side wall.

19. The method of claim 16, wherein the step if inserting the removable collar includes inserting the removable collar to completely surround the interior space of the planter.

20. The method of claim 16, wherein the step of inserting the removable collar includes inserting the removable collar such that the removable collar angles outwardly from the plurality of sidewalls.

21. The method of claim 16, wherein the step of providing the collar member includes providing the collar as comprising a biodegradable material.

22. A green roof planter module, comprising:
a planter including a bottom wall, a plurality of side walls that cooperate with the bottom wall to form an interior space, and at Least one aperture extending through at least one of the side walls of the plurality of side walls;
a removable collar member extending upwardly from at least a select one of the plurality of sidewalls, wherein the collar includes at least one relief therein, and wherein the collar member is adapted to retain a plant matter that extends above the plurality of sidewalls; and
a retainer member the extends into the at least one relief of the collar and the at least one aperture of the at least one sidewall of the planter, thereby removably retaining at least a portion of the collar about the planter.

23. The green roof planter module of claim 22, wherein the retainer member comprises an elastic member that encircles the planter.

24. The green roof planter module of claim 23, wherein the at Least one aperture comprises a plurality of apertures located at intersections between the side walls.

25. The green roof planter module of claim 22, wherein the collar member is Located outside of the interior space of the planter.

26. A green roof planter module, comprising:
a bottom wall adapted to support the planter module from a supporting surface;
a pair of side walls extending upwardly from the bottom wall;
a pair of end walls extending upwardly from the bottom wall, wherein the bottom wall, the side walls and the end walls cooperate to form an interior space; and
a pair of reliefs extending into a portion of the bottom wall and the end walls, wherein the reliefs are adapted to providing clearance between the planter module and a supporting surface to allow a user to grip the planter module.

27. The green roof planter module of claim 26, wherein the bottom wall, the pair of side walls and the pair of end walls are integrally formed.

28. A green roof planter module, comprising:
a planter including a bottom wall; and
a plurality of side walls that cooperate with the bottom wall to form an interior space, wherein each of the side walls includes a top edge and a bottom edge, at least one of the side walls of the plurality of side walls includes a relief extending through the at least one side wall and extending greater than half of a distance between the top edge to the bottom edge of the at least one side wall, wherein the relief is adapted to provide fluid communication between the planter module and a proximate second planter module.

29. The green roof planter module of claim 28, wherein the relief extends downward from the top edge.

30. The green roof planter module of claim 28, wherein the relief is arcuately shaped.

31. A green roof planter module, comprising:
a drainage member including a bottom surface, a top surface having at least one downwardly extending recess, and a plurality of side surfaces; and
a planter separate from the drainage member and including a bottom wall abutting the top surface of the drainage member and having at least one drainage aperture in fluid communication with the at least one recess of the drainage member, thereby allowing fluid communication between the at least aperture and the at least one recess, and wherein the at least one recess extends through at least one of the plurality of side surfaces, thereby providing fluid communication between the planter module and an adjacent planter module.

32. The green roof planter module of claim 31, wherein at least the bottom surface of the drainage member comprises a deformable material.

33. The green roof planter module of claim 32 wherein at least the bottom surface of the drainage member comprises a foam material.

34. The green roof planter module of claim 31, further including:
a removable collar member extending upwardly from at least a select one of the plurality of sidewalls, wherein the collar member is adapted to retain a plant matter that extends above the plurality of sidewalls.

35. The green roof planter module of claim 31, wherein the planter includes at least one downwardly-extending tab adapted to be embedded within the drainage member.
